(19) United States
(12) Patent Application Publication
(10) Pub. No.: US 2014/0332192 A1
(43) Pub. Date: Nov. 13, 2014

(54) SURFACE FEATURES TO ENHANCE BRAZING PROCESS

(71) Applicant: TRANE INTERNATIONAL INC., Piscataway, NJ (US)

(72) Inventors: Ronald Maurice COSBY, II, La Crosse, WI (US); William Burgess FOX, Onalaska, WI (US)

(73) Assignee: TRANE INTERNATIONAL INC., Piscataway, NJ (US)

(21) Appl. No.: 14/274,238

(22) Filed: May 9, 2014

Related U.S. Application Data
(60) Provisional application No. 61/821,432, filed on May 9, 2013.

(51) Int. Cl. B23K 1/20

(52) U.S. Cl. CPC B23K 1/20
USPC 165/177; 228/203; 403/272

(57) ABSTRACT

Embodiments disclosed herein generally relate to methods, systems and apparatuses configured to form and/or configure hydrophobic and/or hydrophilic surface features on the workpieces to enhance a brazing process. The hydrophilic and/or the hydrophobic surface features can be arranged to facilitate directing a melted filler material to where the filler material may be desired, and may also help prevent/reduce the filler material flowing to where the filler material may not be desired. The surface features can be micro milled on a surface of the workpiece.

### FIELD

The disclosure herein relates to a brazing process. More particularly, the disclosure relates to methods, systems and apparatuses of forming surface features on workpieces that may enhance a brazing process.

### BACKGROUND

Brazing is a metal joining process. Typically, a filler material is brought to or slightly above its melting temperature, while protected by, for example, a flux. The melted filler material can then be distributed between two or more close-fitting workpieces by, for example, capillary action. As a result, the workpieces are joined together by the filler material. The workpiece may be a return bend, a header stub, a distributor tube, a braze cup, compressor suction and/or discharge lines, oil separators, valves, accumulators, or other suitable structures.

The brazing process is commonly used in manufacturing, for example, heat exchangers of a heating, ventilation and air conditioning (HVAC) system. Heat exchanger tubes of the heat exchanger, such as for example round tubes, plate fin coils, brazed plate heat exchangers, and microchannel (flat tube) coils, may be joined together by the brazing process.

### SUMMARY

Embodiments disclosed herein generally relate to methods, systems and apparatuses directed to form filler-material-phobic and/or filler-material-philic surface features on the workpieces to enhance a brazing process. The filler-material-phobic surface features may have hydrophobic characteristics; and the filler-material-philic surface features may have hydrophilic characteristics. The workpiece may include a return bend, a header stub, a distributor tube, a braze cup, compressor suction and/or discharge lines, oil separators, valves, accumulators, or other suitable structures.

In some embodiments, hydrophilic and/or the hydrophobic surface features can be arranged on a workpiece to facilitate directing a melted filler material to where the filler material may be desired. In some embodiments, the hydrophilic and/or hydrophobic surface features can be arranged so as to help prevent/reduce the filler material flowing to where the filler material may not be desired. The surface features can be micro milled on the workpiece. In some embodiments, the micro mill process may include mechanical embossment, machining, and/or chemical etching.

In some embodiments, a method of preparing a surface of a workpiece for brazing may include forming hydrophobic surface features at a first area on the workpiece where a filler material may not be desired. In some embodiments, a method of preparing a surface of a workpiece for brazing may include forming hydrophilic surface features at a second area on the workpiece where a filler material may be desired. In some embodiments, the hydrophobic surface features may include pillar-shaped structures.

In some embodiments, a joint may include a first workpiece that is fitted within a second workpiece. The first workpiece and the second workpiece may have an overlapped area. In some embodiments, at least a portion of the overlapped area may be hydrophilic. In some embodiments, the first and/or second workpiece may include a second area that may be hydrophobic. In some embodiments, the second area may be proximate or close to the overlapped area. In some embodiments, the second area may be away from the overlapped area.

Other features and aspects of embodiments will become apparent by consideration of the following detailed description and accompanying drawings.

### BRIEF DESCRIPTION OF THE DRAWINGS

Reference is now made to the drawings in which like reference numbers represent corresponding parts throughout.

FIGS. 1A and 1B illustrate a U-bend joint that can be joined by a brazing process. FIG. 1A illustrates a portion of the U-bend joint. FIG. 1B is an enlarged view of a section 1B in FIG. 1A.

FIGS. 2A and 2B illustrate exemplary surface features that can help make the surface relatively more hydrophobic or hydrophilic. FIG. 2A illustrates one surface feature that can help make the surface relatively more hydrophobic. FIG. 2B illustrates one surface feature that can help make the surface relatively more hydrophilic.

FIGS. 3A to 3E illustrate exemplary workpieces, with which the embodiments as disclosed herein can be practiced. FIG. 3A illustrates a tube to tube joint. FIG. 3B illustrates another tube to tube joint. FIG. 3C illustrates a Tee joint. FIG. 3D illustrates a portion of a micro-channel heat exchanger. FIG. 3E illustrates a portion of a tube and a tube sheet of a heat exchanger.

FIGS. 4A and 4B illustrate an embodiment of a brazed plate heat exchanger. FIG. 4A is a partial front view. FIG. 4B is a sectional view along a line 4B-4B in FIG. 4A.

### DETAILED DESCRIPTION

A brazing process is commonly used in joining two or more metal workpieces. For example, when making heat exchangers of a HVAC system, heat exchanger tubes are often joined together by the brazing process. The brazing process may also be used to join the heat exchanger tubes to a tubesheet in, for example, a shell-and-tube heat exchanger.

In the brazing process, the workpieces are generally close-fitted to help provide a capillary action to attract a filler material. The filler material may be placed near or at where the workpieces fit together. Typically, the workpieces and the filler material are then brought to or slightly above a melting temperature of the filler material, while protected by, for example, a flux. The melted filler material can be distributed between the workpieces by, for example, the capillary action. As a result, the workpieces are joined together by the filler material. The filler material may contain aluminum-silicon, copper, copper-silver, copper-zinc (brass), gold-silver, nickel alloy, silver, amorphous brazing foil using nickel, iron, copper, silicon, boron, phosphorus, or other suitable materials. Issues related to the brazing process may include, for example, failure of the filler material being distributed between the workpieces, and/or the filler material being distributed to places where the filler material may not be desired. Enhancement can be made to the brazing process.

Embodiments disclosed herein generally relate to methods, systems and apparatuses directed to surface features on the workpieces configured to enhance a brazing process that may be filler-material-phobic or filler-material-philic. In some embodiments, a portion of the workpiece can be configured to have surface features to make the portion relatively more hydrophilic to, for example, attract and/or retain a filler material. In some embodiments, a portion of the workpiece can be configured to include surface features to make the portion relatively more hydrophobic to, for example, prevent/reduce the filler material from being attracted to the portion. In some embodiments, the hydrophilic surface and the hydrophobic surface can be arranged to facilitate directing a flow of the melted filler material on the surface of the workpiece during the brazing process. In some embodiments, the surface features can be micro milled on the surface of the workpiece. The embodiments disclosed herein may help direct the filler material to a place where the filler material may be desired, and/or help prevent/reduce the filler material being directed to a place where the filler material may not be desired. The embodiments disclosed herein may allow a more robust brazing process and may help reduce the reliance on a capillary action. Generally, the same principle can be used to attract and/or direct a flux, which is sometimes used with the filler material.

References are made to the accompanying drawings that form a part hereof, and in which is shown by way of illustration of the embodiments in which the embodiments may be practiced. It is to be understood that the embodiments as described herein are generally directed to a filler material. However, the embodiments can also work with a flux or other suitable materials. It is to be understood that the terms used herein are for the purpose of describing the figures and embodiments and should not be regarding as limiting in scope.

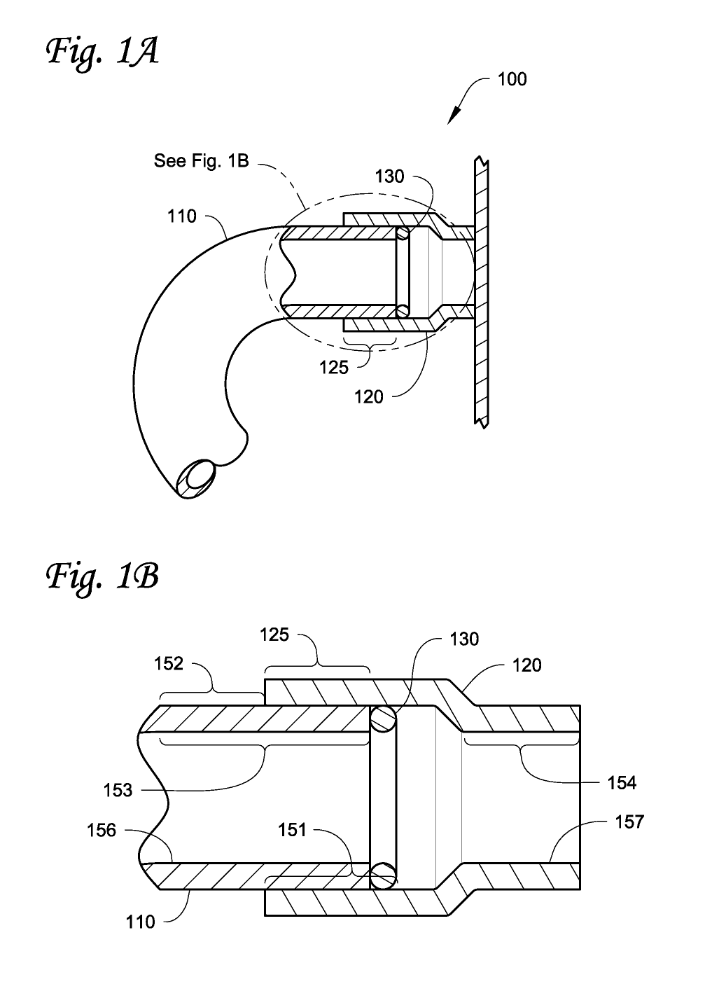

FIGS. 1A and 1B illustrate an embodiment of a portion of a U-bend joint 100. The U-bend joint 100 may be included, for example, in a heat exchanger. The U-bend joint 100 includes a bend tube 110 fitted inside a braze cup 120, forming a joint 125. The bend tube 110 and the braze cup 120 can be joined by a brazing process.

In the illustrated embodiments, a ring-shaped filler material 130 can be positioned, for example, at an end of the bend tube 110 inside the braze cup 120, with the appreciation that the filler material 130 can also be positioned external to the joint 125 formed by the braze cup 120 and the bend tube 110, such as at the end of the braze cup 120. In a brazing process, the joint 125 can be heated to or slightly above the melting point of the filler material 130. The melted filler material 130 can flow between the bend tube 110 and the braze cup 120 at the joint 125 so as to join the bend tube 110 and the braze cup 120.

FIG. 1B is an enlarged view of an area 1B in FIG. 1A. The braze cup 120 includes a first treated surface 151, which can be configured to include features that may help make the first treated surface 151 relatively more hydrophilic. In the illustrated embodiment, the first treated surface 151 includes an area that overlaps with the bend tube 110 in the joint 125, and an area that may contact the filler material 130. In some embodiments, the outer surface of the bend tube 110 that overlaps with the first treated surface 151 of the braze cup 120 may also be a treated surface that is relatively hydrophilic.

The bend tube 110 includes a second treated surface 152, which is generally just external to or away from the joint 125. The second treated surface 152 can be configured to include features that may help make the second treated surface 152 relatively more hydrophobic.

The bend tube 110 has an inner surface 156 and the braze cup 120 has an inner surface 157. A portion 153 of the inner surface 156 can be configured to include features that may help make the inner surface 153 relatively more hydrophobic. A portion 154 of the inner surface 157 can be configured to include features that may help make the inner surface 156 relatively more hydrophobic.

In a brazing process, the melted filler material 130 tends to be attracted by and move along the hydrophilic first treated surface 151. As a result, the first treated surface 151 may facilitate the melted filler material 130 flowing into the joint 125. The hydrophobic second treated surface 152 can generally be relatively repulsive to the melted filter material 130 and can reduce or prevent the migration of the melted filler material 130 along the second treated surface 152. As a result, the second treated surface 152 can help prevent/reduce the melted filler material 130 flowing out of the joint 125.

The treated portion 153 and/or 154 on the inner surface 156, 157 of the bend tube 110 and/or braze cup 120 can help prevent the melted filler material 130 to flow to the inner surfaces 156 and/or 157.

Applying the hydrophilic and/or hydrophobic surface features on different portions of the joint 125 and/or the areas surrounding the joint 125 may help direct the flow of the melted filler material 130 to a desired area and/or reduce/prevent the melted filler material 130 flowing to the undesired area.

The embodiment as illustrated in FIG. 1B includes the filler material 130 positioned inside the braze cup 120. This is exemplary. It is to be appreciated that a filler material can also be positioned external to the joint 125. For example, a filler material may be positioned on the second treated surface 152. Because the second treated surface 152 is generally hydrophobic, the filler material generally may not be held or retained on the second treated surface 152. The filler material can flow toward the first treated surface 151, which is relatively more hydrophilic.

The illustrated embodiment is exemplary. In some embodiments, the portion of the bend tube 110 that overlaps with the braze cup 120 can also be treated to make it relatively more hydrophilic. In some embodiments, only the braze cup 120 is treated to make it relatively more hydrophilic, while the bend tube 110 may not be treated. In some embodiments, the bend tube 110 may not include the hydrophobic second treated portion 152. In some embodiment, the bend tube 110 may be treated to include hydrophilic surface features at the portion that overlaps with the braze cup 120, while the braze cup 120 is not treated. Generally, the workpiece may be treated to include hydrophobic surface features at where the filler material may not be desired. The workpiece may also be treated to include hydrophilic surface features at where the filler material may be desired. In some embodiments, the workpiece may be treated to include both hydrophobic and hydrophilic surface features.

A surface of a material, such as copper, aluminum, steel, can be treated to include surface features that change the hydrophobicity/hydrophilicity of the surface. Generally, the more hydrophobic the surface is, the more difficult for the melted filler material to be retained on the surface. The more hydrophilic the surface is, the easier for the melted filler material to be retained on the surface. At an intersection between a hydrophobic surface and a hydrophilic surface, the melted filler material can generally be drawn toward the hydrophilic surface. This can help to achieve a more robust brazing process and help the brazing process be less sensitive to both over and under sized gaps between the two workpieces of the joint.

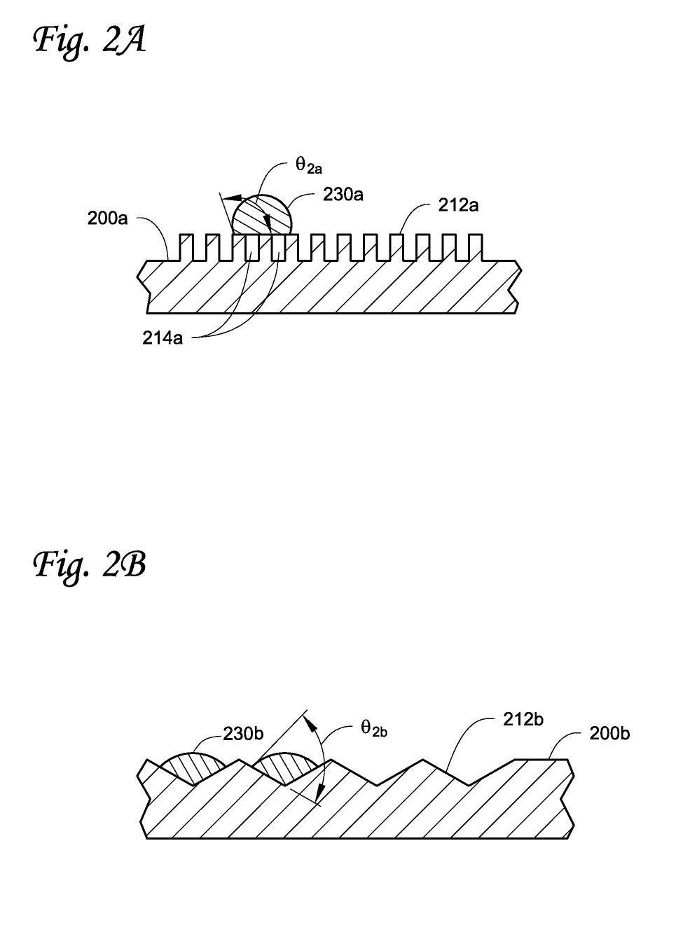

FIGS. 2A and 2B illustrate surface features that can help make the surface relatively more hydrophobic and relatively more hydrophilic respectively.

FIG. 2A illustrates that a surface 200a can be configured to include a plurality of pillar-like structures 212a. When the melted filler material 230a contacts the pillar-like structures 212a, the neighboring pillar-like structures 212a may form air pockets 214a, which may prevent the melted filler material 230a from wetting (or being retained on) the surface 200a. The pillar-like structures 212a can help make the surface 210a relatively more hydrophobic. A contact angle θ₂ₐ, which is the angle where a liquid/vapor interface of the melted filler material 230a meets the solid surface 200a, is typically larger than 90 degrees in this embodiment.

FIG. 2B illustrates that a surface 210b can be configured to include a plurality of valley-like structures 212b. The valley-like structures 212b may help make the surface 210b relatively more hydrophilic. A contact angle θ_{2b}, which is the angle where a liquid/vapor interface of the filler material 230b meets the solid surface 200b, is typically smaller than 90 degrees in this embodiment.

The surface features as illustrated in FIGS. 2A and 2B may be generally created on the surfaces of the workpieces. The surface features, such as illustrated in FIGS. 2A and 2B, can be made, for example, by micro-milling. In some embodiments, the surface features can also be made by other suitable processes.

It is to be appreciated that the surfaces of the workpieces can also be treated with other material, such as a coating to make the surface relatively more hydrophobic or hydrophilic. For example, hydrophobic surface features may be created by applying the surface with oils, proteins, colloids, greases, and/or clays. Hydrophilic surface features may be created by applying to the surface, for example, a wettability agent.

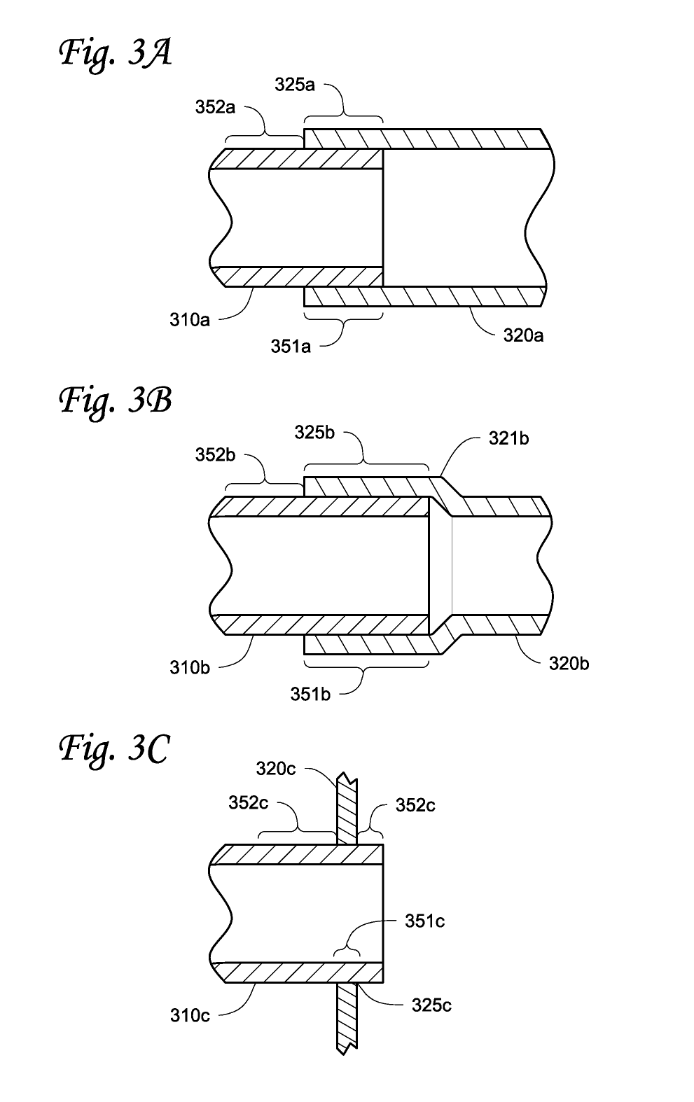

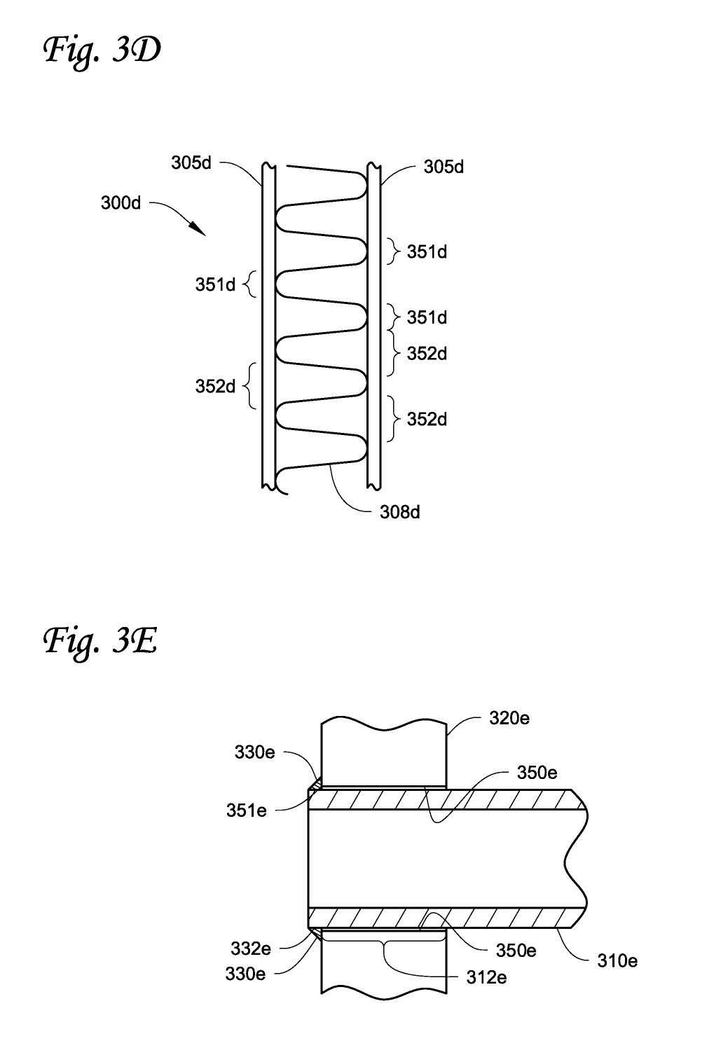

FIGS. 3A to 3F illustrate exemplary embodiments of workpieces, with which the hydrophobic and/or hydrophilic surface features can be used to help a brazing process to join the workpieces. The arrows in the figures illustrate desired flow directions of a melted filler material for the brazing process.

FIG. 3A illustrates a joint 325a that is formed by a first tube 310a and a second tube 320a. In an overlapped region 351a of the first tube 310a and the second tube 320a at the joint 325a, a surface of the first tube 310a and/or the second tube 320a can be configured to include hydrophilic surface features. A second region 352a of the first tube 310a, which is just external to the joint 325a, can be configured to include hydrophobic surface features. In the brazing process, a filler material can be positioned just outside of the joint 325a. The melted filler material can be preferably drawn from the hydrophobic second region 352a to the hydrophilic overlapped region 351a in the brazing process. The second region 352a can also help prevent/reduce the melted filler material flowing away from the joint 325a along the first tube 310a. Likewise, it will be appreciated that outside the joint 325a on the second tube 320a, a surface feature may be included that has a hydrophobic characteristic. It will also be appreciated that the inner surface of the first tube 310a on the other side of the overlapped region 351a can include a hydrophobic characteristic.

FIG. 3B illustrates a joint 325b that is formed by a first tube 310b and a second tube 320b. The second tube 320b has an enlarged braze cup 321b to fit the first tube 310b. In an overlapped region 351b of the first tube 310b and the second tube 320b at the joint 325b, a surface of the first tube 310b and/or the second tube 320b can be configured to include hydrophilic surface features. A second region 352b of the first tube 310b, which is just external to the joint 325b, can be configured to include hydrophobic surface features. In the brazing process, a filler material can be positioned just outside of the joint 325b. The melted filler material can be preferably drawn from the hydrophobic second region 352b to the hydrophilic overlapped region 351b in the brazing process. The second region 352b can also help prevent/reduce the melted filler material flowing away from the joint 325b along the first tube 310b. Likewise, it will be appreciated that outside the joint 325b on the second tube 320b, a surface feature may be included that has a hydrophobic characteristic. It will also be appreciated that the inner surface of the first tube 310b on the other side of the overlapped region 351b can include a hydrophobic characteristic.

FIG. 3C illustrates a Tee joint 325c that is formed by a first tube 310c and a sheet 320c. In an overlapped region 351c of the first tube 310c and the sheet 320c at the Tee joint 325c, a surface of the first tube 310c and/or the sheet 320c can be configured to include hydrophilic surface features. A second region 352c of the first tube 310c, which is just external to the Tee joint 325c from either side of the Tee joint 325c, can be configured to include hydrophobic surface features. In the brazing process, a filler material can be positioned just outside of the Tee joint 325c. The melted filler material can be preferably drawn from the hydrophobic second region 352c to the hydrophilic overlapped region 351c in the brazing process. The second region 352c can also help prevent/reduce the melted filler material flowing away from the joint 325c along the first tube 310c. Likewise, it will be appreciated that outside the joint 325c on the sheet 320c, a surface feature may be included that has a hydrophobic characteristic. It will also be appreciated that the inner surface of the first tube 310c on the other side of the overlapped region 351c can include a hydrophobic characteristic.

FIG. 3D illustrates that hydrophobic/hydrophilic surface features can also be used in a brazing process of making, for example, a micro-channel heat exchanger 300d. Only one neighboring pair of micro-channel tubes 305d is shown. A fin 308d can be attached to the micro-channel tubes 305d via a brazing process. As illustrated, at attachment points 351d, where the fin 308d is attached to the micro-channel tubes 305d, a surface of the micro-channel tubes 305d and/or the fin 351d can be configured to include hydrophilic surface features. A second area 352d, where the fin 351d is not attached to the micro-channel tubes 305d, the surface of the micro-channel tubes 305d and/or the fin 351d can be configured to include hydrophobic surface features. In a brazing process, the melted material can be preferably drawn from the hydrophobic second regions 352d to the hydrophilic attachment points 351d.

FIG. 3E illustrates a tube 310e that is attached to a tube sheet 320e by a brazing process. The tube 310e is generally positioned inside an aperture 350e. As illustrated, it may be desired that the tube 310e is attached to the tube sheet 320e at about an end 351e of the aperture 350e of the tube sheet 320e by a filler material 330e, while the tube 310e is floated inside the aperture 350e so that the tube 310e can thermally expand inside the aperture 350e. If the filler material 330e moves inside the aperture 350e, the filler material 330e may hinder the thermal expansion of the tube 310e, causing tube 310e failure.

To facilitate the brazing process, a surface 351e of the aperture 350e and/or a portion 312e of the tube 310e that corresponds to the aperture 350e may be configured to include hydrophobic surface features; and/or a portion 332e of the tube 310e and/or the tube sheet 320e that corresponds to the desired brazing area can be configured to include hydrophilic surface features. During the brazing process, the hydrophilic surface features can help the filler material 330e to flow to the desired brazing area, and the hydrophobic surface features can help prevent/reduce the filler material 330e flowing into the aperture 350e.

Generally, inner surfaces of the tubes, such as tubes 310a, 320a, 310b, 320b, 310c, 320c, and 310e can be configured to be hydrophobic to prevent/reduce the filler material from being directed to the inner surfaces. (See, for example, FIGS. 1A and 1B for inner surface features.)

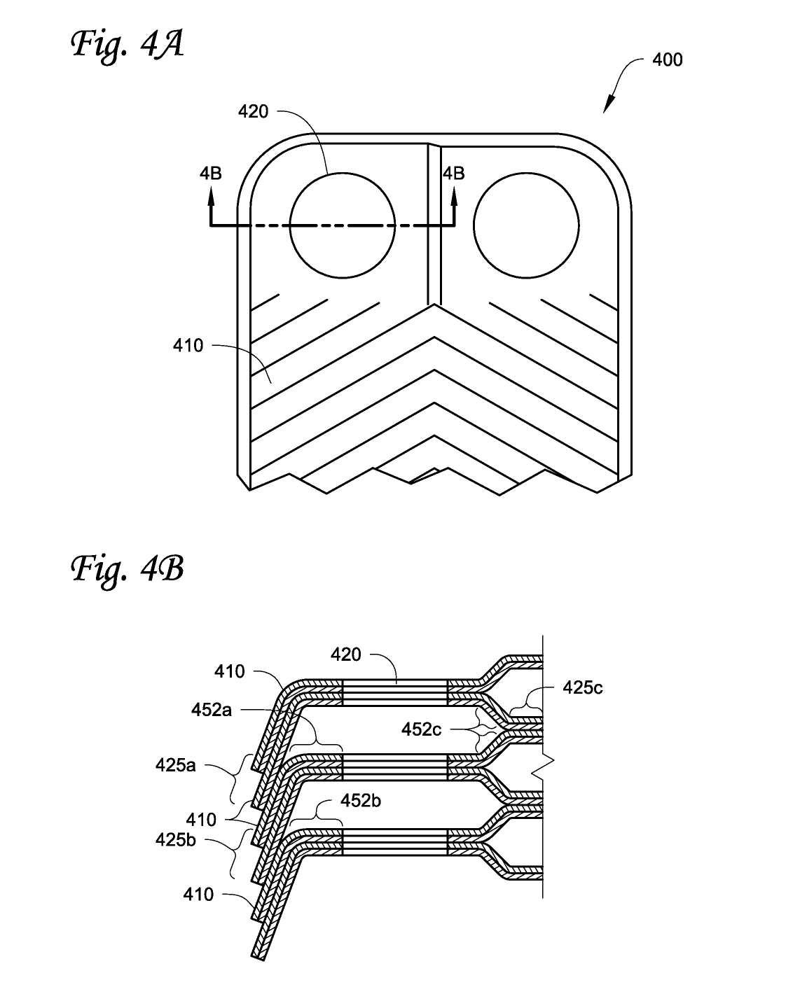

FIGS. 4A and 4B illustrate an embodiment of a brazed plate heat exchanger 400. FIG. 4A illustrates a partial front view of a brazed plate 410 of the brazed plate heat exchanger 400. The brazed plate 410 has an opening 420.

As illustrated in the cross sectional view of FIG. 4B, the brazed plate heat exchanger 400 include a plurality of brazed plates 410 that are brazed together in selected regions. For example, the first regions 425a, 425b and 425c are regions that brazing is desired. The second regions 452a, 452b and 452c, which generally are located next to the first regions 425a, 425b and 425c respectively, are regions that brazing is not desired. The first regions 425a, 425b and 425c can be treated to be relatively hydrophilic to help attract and retain a filler material of the brazing process. The second regions 452a, 452b and 452c can be treated to be relatively hydrophobic to help prevent/reduce the filling materials from attaching.

It is to be appreciated that the embodiments as illustrated herein are exemplary. Other areas of the workpiece, such as an inner surface of a tube, or the areas between the brazing points of typical brazed plate heat exchangers may also be treated to include hydrophobic and/or hydrophilic surface features to help reduce unwanted filler material. The brazing points in a brazed plate heat exchanger may be treated with a hydrophilic surface to attract filler material where it is needed.

It is to be appreciated that the joints as illustrated in FIGS. 3A to 3E can be orientated vertically, horizontally, or in other angles during the brazing process. Because the flow direction of the melted filler material is directed or facilitated by the hydrophobicity of the tube surfaces, the gravity effect on the flow direction of the melted filler material can be compensated by the hydrophobicity/hydrophilicity of the tube surfaces. Therefore, the hydrophobicity/hydrophilicity of the tube surfaces can also help the brazing process regardless the orientations of the joints.

Further, in some embodiments, the joint may be relatively difficult to access, such as when the joint is located in a tight space. During the brazing process, the joint can be heated from a side that may be relatively accessible so as to melt the filler material. The melted filler material can be directed into other areas of the joint by the hydrophilic and/or hydrophobic surface features. This may help the brazing process when the joint is relatively more difficult to reach.

By using the hydrophilic and/or hydrophobic surface features, the filler material can be directed to where the filler material may be needed during a brazing process, while reducing/preventing the filler material flowing to where the filler material may not be desired. This may also help reduce the usage of the filler material during the brazing process. The hydrophilic and/or hydrophobic surface features can also help reduce the reliance on capillary action to attract and/or retain the filler material, so that the brazing process can be more robust. Because of the reduction in reliance on the capillary action, the brazing process may be less sensitive to both over and under sized gaps between the two workpieces.

It is to be appreciated that the embodiments as illustrated in FIGS. 1A, 1B, 3A-3E, 4A and 4B are exemplary. In general, the filler-material-phobic (e.g. hydrophobic) surface features can be applied to where the filler-material is not desired, the filler-material-philic (e.g. hydrophilic) surface features can be applied to where the filler-material is desired.

With regard to the foregoing description, it is to be understood that changes may be made in detail, without departing from the scope of the present invention. It is intended that the specification and depicted embodiments are to be considered exemplary only, with a true scope and spirit of the invention being indicated by the broad meaning of the claims.

What claimed is:

1. A method of preparing a surface of a workpiece for brazing, comprising:
forming filler-material-philic surface features at a first area on the workpiece where a filler material is desired; or forming filler-material-phobic surface features at a second area on the workpiece where a filler material is not desired.

2. The method of claim 1, wherein the workpiece is treated with micro milling.

3. The method of claim 1, wherein the filler-material-philic surface features include pillar-shaped structures.

4. The method of claim 1, wherein the filler-material-phobic surface features include valley-like structures.

5. The method of claim 1, wherein the filler-material-philic surface features include hydrophilic surface features.

6. The method of claim 1, wherein the filler-material-phobic surface features include hydrophobic surface features.

7. A method of brazing process, comprising
providing filler-material-philic surface features at a first area on a first workpiece where a filler material is desired;
positioning the first area of the first workpiece close to a second workpiece; and
melting a filler material near the first area of the first work piece.

8. The method of claim 7, wherein the filler-material-philic surface features include hydrophilic surface features.

9. The method of claim 7, further comprising:
forming filler-material-phobic surface features at a second area on the first workpiece where the filler material is not desired.

10. The method of claim 8, wherein the filler-material-phobic surface features include hydrophobic surface features.

11. An apparatus, comprising:
a first workpiece; and
a second workpiece;
wherein a first portion of the first workpiece and a first portion of the second workpiece define an overlapped area that includes filler-material-philic surface features,
a second portion of the first workpiece outside of the overlapped area includes filler-material-phobic surface features, and
the first portion of the first workpiece and the second portion of the first workpiece are next to each other.

12. The apparatus of claim 11, wherein the second portion of the first workpiece includes a plurality of pillar-like structures.

13. The apparatus of claim 11, wherein the overlapped area includes a plurality of valley-like structures.

14. The apparatus of claim 11, wherein the apparatus is a heat exchanger, the first workpiece is a first heat exchange tube, and the second workpiece is a second heat exchange tube.

15. The apparatus of claim 11, wherein the first work piece and the second work piece are joined by a brazing process, the overlapped area is where a filler material of the brazing process is desired, and the second portion of the first workpiece is where a filler material of the brazing process is not desired.

16. The apparatus of claim 11, wherein the filler-material-philic surface features includes hydrophilic surface features.

17. The apparatus of claim 11, wherein the filler-material-phobic surface features includes hydrophobic surface features.

18. The apparatus of claim 11, further comprising a second portion of the second workpiece outside of the overlapped area, the second portion of the second workpiece includes filler-material-phobic surface features, and
the first portion of the second workpiece and the second portion of the second workpiece are next to each other.
